(19) United States
(12) Patent Application Publication
(10) Pub. No.: US 2010/0319044 A1
(43) Pub. Date: Dec. 16, 2010

(54) Efficient Distribution of Remote Storage Data

(75) Inventors: David John Agans, Amherst, NH (US); Bang Chang, Medway, MA (US)

Correspondence Address: PROSKAUER ROSE LLP, ONE INTERNATIONAL PLACE, BOSTON, MA, 02110, US

(73) Assignee: Seachange International, Inc., Acton, MA (US)

(21) Appl. No.: 12/564,402

(22) Filed: Sep. 22, 2009

Related U.S. Application Data
(60) Provisional application No. 61/187,445, filed on Jun. 16, 2009.

(51) Int. Cl. H04N 7/173; H04N 5/76

(52) U.S. Cl. 725/115; 386/E05.068

(57) ABSTRACT

Described are apparatuses and methods for remote recording of digital data. A remote server digital video recorder (RS-DVR) server system includes one or more computer readable storage devices and a digital video recorder (DVR) server. The DVR server includes an input controller, a buffer unit, and a storage controller. The input controller receives an original data stream. The buffer unit is coupled to the input controller and receives and stores at least a portion of the original data stream from the input controller. The storage controller is coupled to the buffer unit and controls direct memory access to the one or more computer readable storage devices for writing one or more subscriber data streams copied from the original data stream. Each subscriber data stream is associated with a subscriber and written to a storage device location in the one or more computer readable storage devices associated with the subscriber.

### RELATED APPLICATIONS

This application claims priority to and benefit of U.S. provisional patent application Ser. No. 61/187,445, filed on Jun. 16, 2009, the entire contents of which are incorporated herein by reference.

### FIELD OF THE INVENTION

The present invention relates generally to computer-implemented methods and apparatuses, including computer program products, for remote storage of digital video.

### BACKGROUND OF THE INVENTION

A digital video recorder (DVR), or personal video recorder (PVR), is a device that records video in a digital format to a disk drive or other computer readable storage device. In one embodiment, a DVR can be integrated in a stand-alone set-top box typically located at a user's premises. A DVR operates in a similar fashion to a traditional video cassette recorder (VCR)—i.e., a user can instruct the DVR to record a particular video stream from a provider (e.g., a program broadcast by a local cable TV company), which results in that particular video stream being recorded to the disk drive for later viewing by the user.

Recently, remote storage digital video recorders (RS-DVR), also referred to as network-PVRs (nPVR), have been introduced as a new service for users. A RS-DVR is a DVR remotely located from a user's premises. Typically, a RS-DVR is located at a provider's head-end.

### SUMMARY OF THE INVENTION

One approach to recording of digital data is remote storage of digital data. In one aspect, there is a remote server digital video recorder (RS-DVR) server system. The RS-DVR system includes one or more computer readable storage devices and a digital video recorder (DVR) server. The DVR server includes an input controller, a buffer unit, and a storage controller. The input controller is for receiving an original data stream. The buffer unit is coupled to the input controller and is for receiving and storing at least a portion of the original data stream from the input controller. The storage controller is coupled to the buffer unit and is for controlling direct memory access to the one or more computer readable storage devices for writing one or more subscriber data streams copied from the original data stream. Each subscriber data stream is associated with a subscriber and written to a storage device location in the one or more computer readable storage devices associated with the subscriber.

In another aspect, there is a computer-implemented method for remote recording of digital data. The computer-implemented method includes receiving, by an input controller device of a digital video recorder (DVR) server, an original data stream. The computer-implemented method also includes receiving and storing, by a buffer unit, at least a portion of the original data stream from the input controller. The computer-implemented method also includes recording, using direct memory access, one or more subscriber data streams copied from the original data stream to one or more computer readable storage devices. Each subscriber data stream is associated with a subscriber and written to a storage device location in the one or more computer readable storage devices associated with the subscriber.

In another aspect, there is a computer program product tangibly embodied in a machine-readable storage device. The computer program product includes instructions being operable to cause a data processing apparatus to receive, by an input controller device of a digital video recorder (DVR) server, an original data stream. The computer program product also includes instructions being operable to cause a data processing apparatus to receive and store, by a buffer unit, at least a portion of the original data stream from the input controller. The computer program product also includes instructions being operable to cause a data processing apparatus to record, using direct memory access, one or more subscriber data streams copied from the original data stream to one or more computer readable storage devices. Each subscriber data stream is associated with a subscriber and written to a storage device location in the one or more computer readable storage devices associated with the subscriber.

In other examples, any of the aspects above can include one or more of the following features. The DVR server can be a digital television headend server. The original data stream can include a video stream, an audio stream, a multimedia stream, or any combination thereof. The input controller can be adapted to receive the original data stream based on one or more selections by one or more subscribers. The input controller can be adapted to ignore data streams not selected by at least one subscriber. The input controller can be adapted to further receive one or more additional original data streams. At least one of the one or more subscriber data streams can be striped across multiple disk drives using parity information. The parity information can be generated based only on data from the at least one of the one or more subscriber data streams and stored on a disk drive separate from the multiple disk drives for redundancy purpose.

In some examples, the system can further include an internal bus coupling the DVR server with the one or more computer readable storage devices. The internal bus can include a Serial Attached SCSI bus. The one or more computer readable storage devices can include one or more Network Attached Storage (NAS) devices, one or more Storage Area Network (SAN) devices, or any combination thereof. The system can further include an InfiniBand or Ethernet network coupling the server with the one or more computer readable storage devices. The system can further include a second DVR server, which can include a second input controller, a second buffer unit and a second storage controller. The second input controller can be for receiving the original data stream. The second buffer unit can be coupled to the second input controller and can be for receiving and storing at least portions of the original data stream from the second input controller. The second storage controller can be coupled to the second buffer unit and can be for controlling direct memory access to the one or more computer readable storage devices for writing at least one subscriber data stream copied from the original data stream. The at least one subscriber data stream can be associated with at least one subscriber and written to a storage device location in the one or more computer readable storage devices associated with the at least one subscriber. The input controller can be adapted to receive the original data streams in a variable bit rate format and store at least one of the one or more subscriber data streams in the variable bit rate format. At least one of the one or more subscriber data streams can include an index file generated by the DVR server.

Any of the above implementations can realize one or more of the following advantages. The complexity and expense of the RS-DVR server system can advantageously be reduced by not requiring the substantial input hardware (e.g., gigE ports) as required to handle the bandwidth of recorded video streams in the prior art system. Furthermore, more efficient processing can advantageously be achieved by performing processing on a per-program basis before duplicate data streams are produced. As a result, each RS-DVR server can advantageously support a greater number of subscribers, which can reduce the server cost per subscriber.

The details of one or more examples are set forth in the accompanying drawings and the description below. Further features, aspects, and advantages of the invention will become apparent from the description, the drawings, and the claims. The drawings are not necessarily to scale, emphasis instead generally being placed upon illustrating the principles of the invention.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a block diagram showing a RS-DVR server system according to the prior art.

FIG. 2 is a block diagram showing a RS-DVR server system according to a first embodiment.

FIG. 3 is a block diagram showing a RS-DVR server system according to a second embodiment.

FIG. 4 is a flowchart depicting operation of a RS-DVR server system.

FIG. 5 is a block diagram showing a RS-DVR server unit according to one embodiment.

### DESCRIPTION OF THE INVENTION

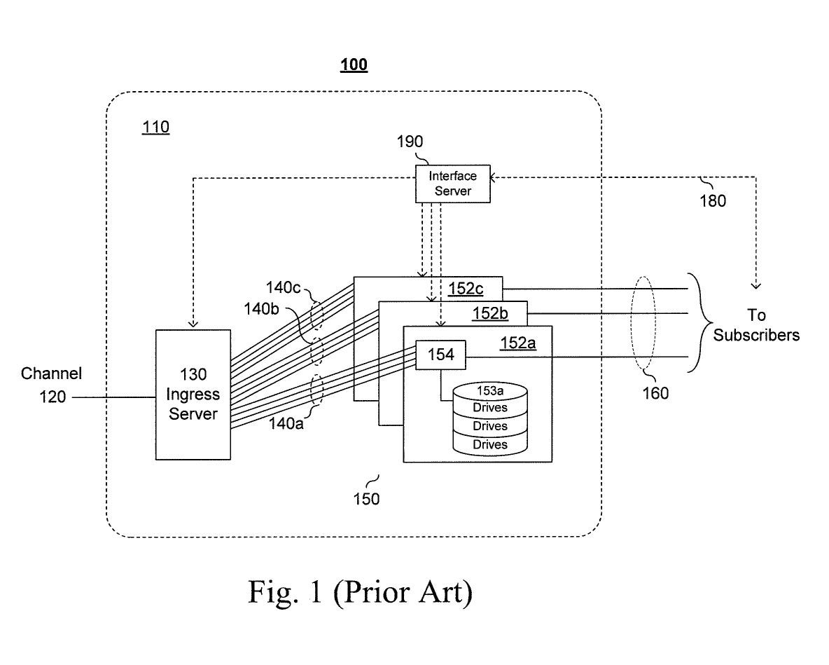

FIG. 1 is a block diagram showing an exemplary network 100 with devices relating to the processing and storage of data streams into RS-DVRs according to the prior art. The network 100 includes a RS-DVR server system 110, which can be located, for example, at a headend system. The RS-DVR server system 110 can be connected to one or more providers (not shown) of data streams (e.g., video streams, audio streams, multimedia or program streams, and/or other streams of information). In one embodiment, for example, a data stream can include a single channel of television programming. FIG. 1 illustrates that RS-DVR server system 110 is connected to one data stream via connection 120, but additional data streams can be provided over one or more additional connections not shown. The RS-DVR server system 110 can receive data streams as, for example, point-to-multipoint data transmissions (e.g., IP multicast or broadcast) or point-to-point data transmissions (e.g., IP unicast) from connection 120. The RS-DVR server system 110 is coupled to one or more users (not shown) via subscriber lines 160. In some embodiments, the subscriber lines 160 can lead into a “last mile” network for providing connectivity to customer premises equipment.

The RS-DVR server system 110 includes an ingress server 130 (e.g., an ingest server) coupled to one or more RS-DVR units 152a, 152b, 152c, generally 152, and an interface server 190. Each RS-DVR unit 152, in turn, can include a stream server 154 and one or more disk drives 153 or other computer-readable storage device. Through the connection 120 and/or other connections not shown, the ingress server 130 can receive, for example, data streams from television station providers (e.g., national, regional, and/or local television station providers). The ingress server 130 is responsible for determining if one or more programs included in one or more of the received data streams should be recorded by one of the RS-DVR units 152. A subscriber transmits a request to record a particular program over an uplink connection 180 to the interface server 190 (e.g., a software and/or hardware scheduler). For each subscriber request, the ingress server 130 can make a separate copy of the requested program and transmit the program to one or more of the RS-DVR units 152. For example, each RS-DVR unit 152 can be associated with multiple users that have requested to record a data stream from channel 120. In FIG. 1, the ingress server 130 is making 12 duplicate data streams from the original data stream from channel 120 based on 12 user requests, and transmits each duplicate data stream, grouped as 140a, 140b, and 140c, to the respective RS-DVR unit 152 associated with the user who requested the recording.

The ingress server 130 transmits the data streams 140a, 140b, and 140c to the RS-DVR units 152 via an intermediate network (not shown), such as a gigabit Ethernet (GigE) network. A separate and/or unique copy of the requested program may be required, regardless of whether multiple subscribers request the same program, in order to comply with copyright laws. For example, if five hundred users each have instructed the RS-DVR server system 110 to record the same program, then the ingress server 130 must make five hundred duplicate data streams of the selected program, and transmit all five hundred data streams over the intermediate network to be recorded in the RS-DVR units 152. The RS-DVR server 154 must receive the duplicate data streams via the intermediate network, process each data stream, and write each data stream to the disk drives 153.

Accordingly, such prior art systems have a number of scalability problems. First, in order to accommodate anticipated numbers of subscriber-initiated recordings of video programming, the intermediate network is required to have very high bandwidth. For example, a typical GigE port can simultaneously handle approximately 250 standard definition (SD) video streams. But, in order to handle stream volumes in the range of thousands of streams (e.g., 3000-4000), the cost of an intermediate GigE network becomes increasingly expensive. Such scalability problem becomes exacerbated with high definition (HD) video streams, whereby the handling capacity of such ports becomes significantly less. Second, the RS-DVR server 154 must have large network and processing capacity to receive and record the anticipated numbers of duplicate data streams. Alternatively, the RS-DVR server 154 must support fewer number of subscribers in order to reduce the number of duplicate data streams, resulting in higher server cost per subscriber.

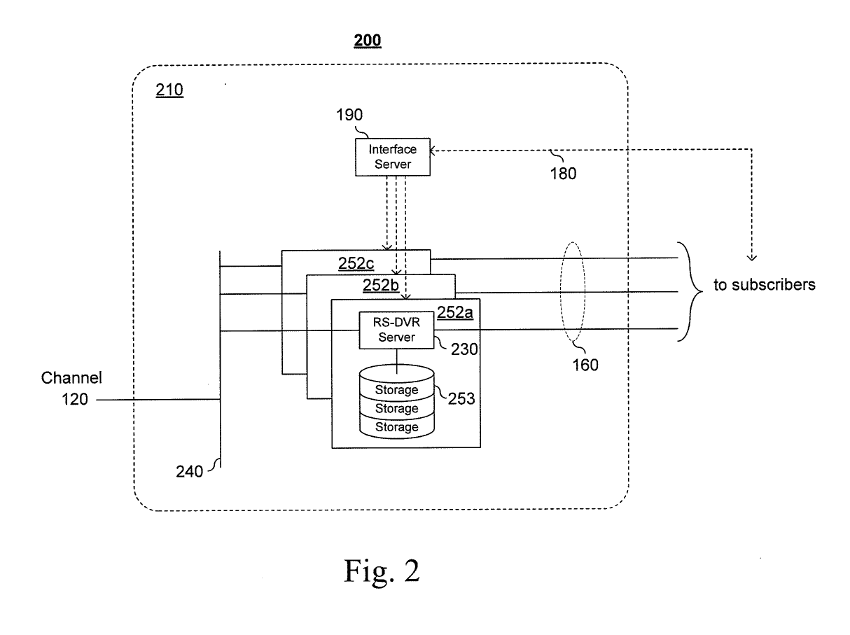

FIG. 2 is a block diagram showing an exemplary network 200 with devices relating to the processing and storage of ingest data streams into RS-DVRs according to some embodiments of the invention. The network 200 includes a RS-DVR server system 210, which can be located, for example, at a headend system. The RS-DVR server system 210 can be connected to one or more providers (not shown) of data streams. FIG. 2 illustrates that RS-DVR server system 210 is connected to one data stream via connection 120, but additional data streams can be provided over one or more additional connections not shown. The RS-DVR server system 210 is coupled to the one or more users (not shown) via subscriber lines 160.

The RS-DVR server system 210 includes an internal network 240, one or more RS-DVR units 252a, 252b, 252c, generally 252, and the interface server 190. The internal network 240 can be coupled to the one or more provider networks (not shown) via connection 120 and/or other connections not shown. The RS-DVR units 252 are coupled to the internal network 240. Each RS-DVR unit 252 can include a RS-DVR server 230 and one or more storage devices 253 (e.g., disk drives) or other computer-readable storage device. In some embodiments, for example, a storage device 253 can be a rack of multiple disk drives. In other embodiments, the RS-DVR server 230 can be co-located with the storage device 253. In some embodiments, the RS-DVR server 230 can be directly connected to the storage device 253 over an internal bus. In yet other embodiments, the RS-DVR unit 252 can include 7RU, 72×1TB SATA drives.

The RS-DVR server 230 can advantageously perform ingest and streaming functions. As an ingress/ingest server, the RS-DVR server 230 can be responsible for determining if one or more programs included in one or more of the received data streams should be recorded to the disc drive 253. For each user's request to record a particular program, the RS-DVR server 230 can make a separate copy of the program and transmit the program directly to the storage device 253. For example, in some embodiments, upon receiving a user request to record a specific program from the interface server 190, the RS-DVR server 230 can open a transient memory buffer, which can contain a few second of video, in order to receive and store the data stream. The RS-DVR server 230 can then transmit data from the transient memory buffer to a user specific disk location on the storage device 253 using, for example, direct memory access (DMA) technology. If there are additional user requests to record the same program, then the RS-DVR server 230 can transmit data from the same transient memory buffer to the appropriate user specific disk location(s) using DMA. Use of a single transient memory buffer for a single data stream requested by multiple users advantageously reduces the number of memory buffers and overhead required to ingest data.

In some embodiments, DMA can allow certain hardware subsystems, such as storage controllers, within a computer to access one or more storage devices for reading and/or writing data independently of another processing unit such as a CPU. For example, hardware systems can use DMA in disk drive controllers, graphics cards, network cards and/or sound cards. Use of DMA can advantageously reduce processing overhead required to read from or write data to storage devices.

In some embodiments, the RS-DVR server 230 can ignore data streams until there is a recording request specified by the interface server 190. Accordingly, the RS-DVR server 230 does not have to buffer any data stream in memory absent at least one subscriber request to record a specified program. Rather, the RS-DVR server 230 can open a memory buffer only in response to at least one subscriber request to record the specific program.

In supplemental embodiments, the RS-DVR server 230 can also be responsible for additional processing of each of the received data streams or programs to be copied, before the RS-DVR makes a copy for each requesting user. For example, the RS-DVR server 230 can perform compression of the buffered data streams and/or modification of the buffered data streams (e.g., conversion between constant bit rate data streams and/or variable bit rate data streams). In an alternative or supplemental embodiment, the RS-DVR server 230 can perform an indexing function on one or more data streams. Indexing processing can include, for example, flagging points in the data stream for use during playback (e.g., trick play). Subsequent to the additional processing, the RS-DVR server 230 can then make the appropriate number of data stream copies of the processed data stream and then record the data stream to the disc drive 253.

As a streaming server, the RS-DVR server 230 can also be responsible for receiving instructions from the interface server 190 to playback selected data streams and, based on the received instructions, retrieving the selected data stream from the storage device 253 and streaming the data stream to the subscriber via lines 160. As part of its streaming responsibilities, the RS-DVR server 230 can verify that the requested data stream is available within the unique storage space allotted to the requesting user (i.e., a user may only request playback for data streams previously recorded in his/her personal RS-DVR storage space).

In FIG. 2, the RS-DVR server system 210 is located between providers of data streams (via line 120) and the subscribers (via lines 160), but other configurations can also be used. For example, the RS-DVR server system 210 can be coupled to providers of data streams and to subscribers via the same access network. More generally, the RS-DVR server system 210 can be any system remotely located from the user premises.

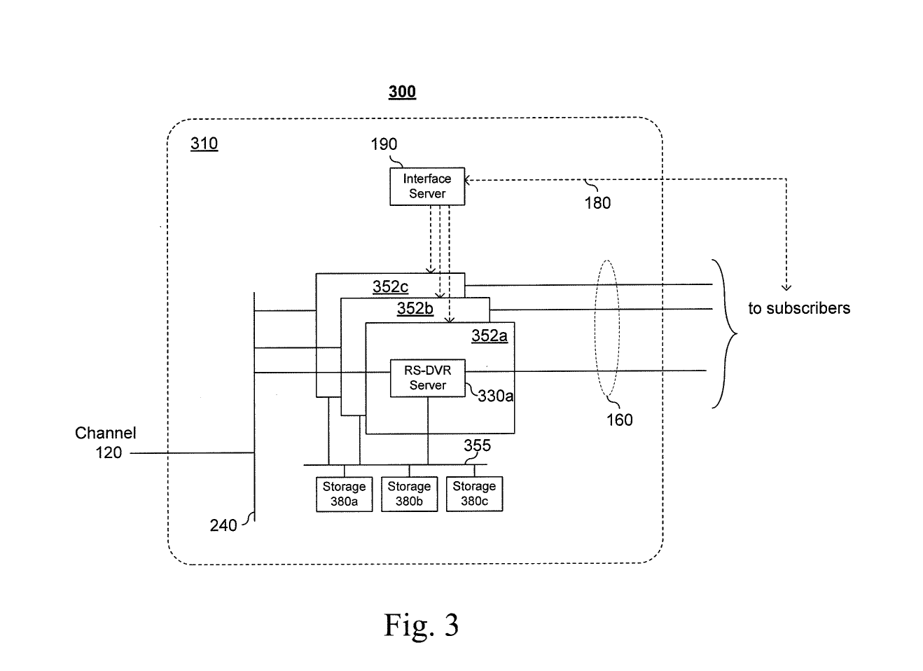

FIG. 3 is a block diagram showing an exemplary network 300 with devices relating to the processing and storage of ingest data streams into RS-DVRs according to other embodiments of the invention. The network 300 includes a RS-DVR server system 310, which can be located, for example, at a headend system. The RS-DVR server system 310 can be connected to one or more providers (not shown) of data streams via connection 120 and/or other connections (not shown). The RS-DVR server system 310 is coupled to the one or more users (not shown) via subscriber lines 160.

The RS-DVR server system 310 includes the internal network 240, one or more RS-DVR units 352a, 352b, 352c, generally 352, and the interface server 190. The RS-DVR units 352 are coupled to the internal network 240. Each RS-DVR unit 352 can include a RS-DVR server 330a, generally 330. RS-DVR units 352 can be coupled, via a network 355, to one or more network storage devices 380a, 380b, 380c, generally 380. Network storage devices 380 can be, for example, a Network Attached Storage (NAS) device, a Storage Area Network (SAN) device, or any other computer-readable storage device accessible over network 355. Network 355 advantageously allows distributed access by the one or more RS-DVR units 352 to each network storage device 380. The network 355 can be based on, for example, InfiniBand and/or Ethernet.

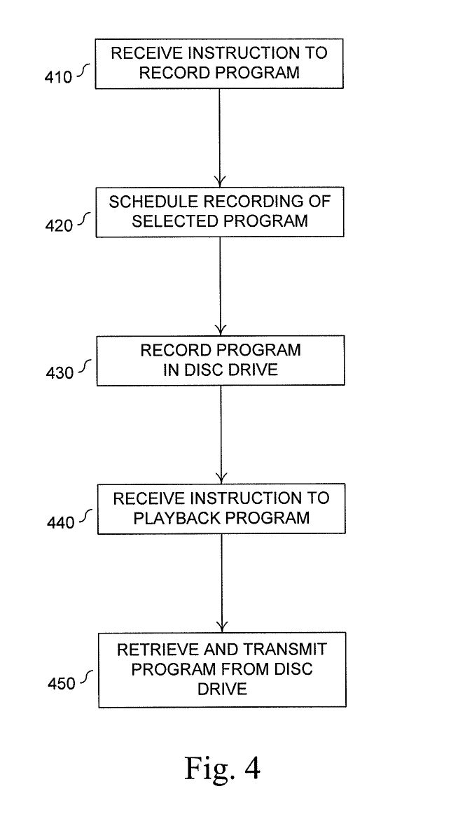

FIG. 4 is a flowchart 400 depicting operation of RS-DVR server systems 210 and/or 310, which includes receiving an instruction to record a program (410), scheduling recording of the selected program (420), recording the selected program in a storage device 253 or network storage device 380 (430), receiving an instruction playback a selected program (440), and/or retrieving from the storage device 253 or network storage device 380 and then transmitting the program to the requesting user (450). Subscribers can schedule for certain programs to be recorded (410) by communicating with the interface server 190. In some embodiments, for example, a user can instruct the interface server 190 to record a certain TV channel at a specified time. Alternatively, the user can simply specify the name of the program and the date, and the interface server 190 can automatically determine from a backend database (not shown) on what channel and at what time the program is being shown.

The interface server 190 can schedule recording of the selected program (420) by instructing the RS-DVR unit 252/352 associated with the requesting user to record the specified program. In some embodiments, for example, the instruction can include the time of the selected program, an identifier of the requesting user, and/or an IP multicast address associated with the TV channel and/or selected program. In some embodiments, each RS-DVR unit 252/352 can include a table of current and/or future programs that have been scheduled to be recorded. When a scheduled time arrives, the RS-DVR server 230/330 can open up a session for the specified IP multicast address and begin receiving the data stream for processing and/or copying (430). Based on the user's ID, the copied data stream can then be transferred and stored to the appropriate storage location on the storage device 253 or network storage device 380.

When more than one user associated with the same RS-DVR unit 252/352 has scheduled to record the same program at the same time, the RS-DVR unit 252/352 can combine these entries into one entry. For example, the internal schedule table can include a single entry for the specified IP multicast address and the time, with the identifier for each requesting user. When the specified time arrives, the RS-DVR server 230/330 will, as before, open up a single session to receive the specified data stream. Based on the list of user IDs in the scheduled entry, the RS-DVR can then make the appropriate number of copies and subsequently transfer and store each data stream to the storage locations on the storage device 253 or network storage device 380 associated with each user (430).

In some embodiments, the interface server 190 can also allow the user to manage their account via a graphical user interface. For example, the interface server 190 can allow the user to view the available programs that are stored on their remote DVR. The interface server 190 can also allow the user to request playback (440) and/or to delete selected program(s). If playback is requested, the respective RS-DVR unit 252/352 can retrieve the data stream and transmit the data stream to the requesting user for viewing (450). In an alternative or supplemental embodiment, the interface server 190 can also allow the user to modify their account options. For example, the user can request, via the interface server 190, to upgrade their account (e.g., increase the amount of available disc space that they are allowed to record programs onto).

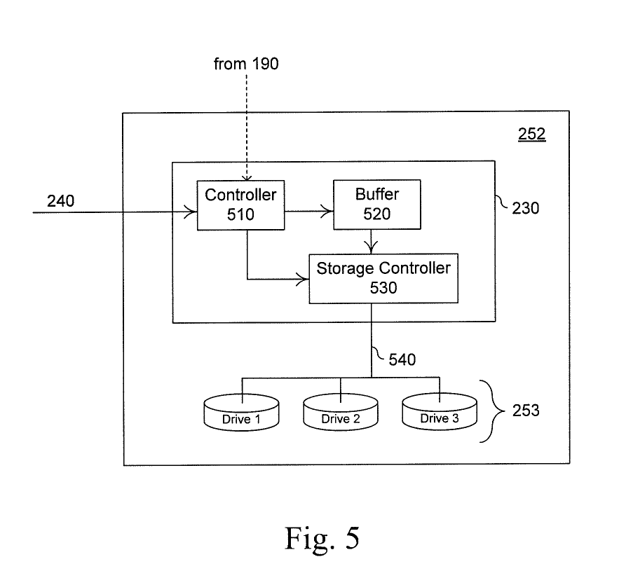

FIG. 5 is a block diagram showing an exemplary RS-DVR unit 252. The RS-DVR server 230 can include a controller 510, a buffer unit 520, a storage controller 530 (e.g., a disc controller), and an internal network 540. A similar configuration of the controller 510, the buffer unit 520, and the storage controller 530 can also be used for the RS-DVR server 330, in which case the internal network 540 can be shared among one or more RS-DVR servers 330. The buffer unit 520 can include one or more individual buffers. In some embodiments, an individual buffer can store one megabyte of program data. The internal network 540 can be an internal bus such as, for example, Serial Attached SCSI (SAS). In other embodiments, the internal network 540 can be based on, for example, InfiniBand and/or Ethernet. The RS-DVR server 330 can also include the controller 510, the buffer unit 520, and the storage controller 530.

The controller 510 can receive a list of requested programs from the interface server 190. Based on the list of requested programs, the controller 510 can maintain, in an internal memory unit (not shown), a list and/or table of scheduled programs to be recorded in the future. In an alternative or supplemental embodiment, the list and/or table of scheduled programs can be maintained remotely (e.g., at the interface server 190) and instructions can be sent to the controller 510 on a real-time basis to record specified programs.

At the arrival of each time on the list, the controller 510 can open up a session and listen for transmissions matching the specified information (e.g., IP multicast address) from the internal network 240 over an I/O port, such as a GigE port (not shown). Whereas the RS-DVR unit can receive only original program transmissions as opposed to copies of such transmission, the RS-DVR unit can advantageously require less network and/or processing capacity as compared to the RS-DVR server 154 in the prior art system 110. For example, the network capacity of the RS-DVR server 230/330 can include a number of ports sufficient to receive transmissions corresponding to the maximum number of available television programming channels. As a result, the RS-DVR server 230/330 can support a greater number of subscribers and/or can reduce the server cost for each subscriber.

As the controller 510 receives the subscriber-requested video program data, the controller can write the program data into one of the buffers in the buffer unit 520. Once the buffer is filled, the controller 510 can direct the storage controller 530 to read the program data from the buffer and perform a memory write of the data to one or more of the storage devices 253 or network storage device 380 assigned to the requesting subscriber(s) for storage and later playback. According to some embodiments, the storage controller 530 can read the program data from the buffer over a PCI bus and can write the data to one or more of the storage devices 253 over a Serial Attached SCSI (SAS) or to one or more of the network storage device 380 over network 355. The controller 510 can instruct the storage controller 530 to which location on which drive the data stored in buffer unit 520 should be copied and stored to. This process can continue until the entire program data comprising the requested program is recorded on the storage devices 253 or network storage devices 380, resulting in separate copies of the program being recorded for each of the requesting subscribers.

According to some embodiments, the recorded data streams for a subscriber can be stored on one of the storage devices 253 or network storage device 380 assigned to that subscriber. Alternatively, the recorded data streams can be striped across multiple drives, with or without parity for redundancy purposes. In some embodiments, parity information can be kept separate for each subscriber.

In some embodiments, before the copies of the data streams are recorded on the storage devices 253 or network storage device 380, the controller 510 can perform processing on the received data stream. For example, the controller 510 can perform compression of the buffered data streams and/or modification of the buffered data streams (e.g., conversion between constant bit rate data streams and/or variable bit rate data streams).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device (e.g., a computer-readable storage device), for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed:

1. A remote server digital video recorder (RS-DVR) server system comprising:
one or more computer readable storage devices; and
a digital video recorder (DVR) server comprising:
an input controller for receiving an original data stream;
a buffer unit, coupled to the input controller, for receiving and storing at least a portion of the original data stream from the input controller; and
a storage controller, coupled to the buffer unit, for controlling direct memory access to the one or more computer readable storage devices for writing one or more subscriber data streams copied from the original data stream, each subscriber data stream associated with a subscriber and written to a storage device location in the one or more computer readable storage devices associated with the subscriber.

2. The system of claim 1 wherein the DVR server is a digital television headend server.

3. The system of claim 1 wherein the original data stream comprises a video stream, an audio stream, a multimedia stream, or any combination thereof.

4. The system of claim 1 wherein the input controller is adapted to receive the original data stream based on one or more selections by one or more subscribers.

5. The system of claim 1 wherein the input controller is adapted to ignore data streams not selected by at least one subscriber.

6. The system of claim 1 wherein the input controller is adapted to further receive one or more additional original data streams.

7. The system of claim 1 wherein at least one of the one or more subscriber data streams is striped across multiple disk drives using parity information, the parity information generated based only on data from the at least one of the one or more subscriber data streams and stored on a disk drive separate from the multiple disk drives for redundancy purpose.

8. The system of claim 1 further comprising an internal bus coupling the DVR server with the one or more computer readable storage devices.

9. The system of claim 8 wherein the internal bus comprises a Serial Attached SCSI bus.

10. The system of claim 1 wherein the one or more computer readable storage devices comprise: Network Attached Storage (NAS) devices, Storage Area Network (SAN) devices, or any combination thereof.

11. The system of claim 10 further comprising an InfiniBand or Ethernet network coupling the server with the one or more computer readable storage devices.

12. The system of claim 10 further comprising a second DVR server, the second DVR server comprising:
a second input controller for receiving the original data stream;
a second buffer unit, coupled to the second input controller, for receiving and storing at least portions of the original data stream from the second input controller; and
a second storage controller, coupled to the second buffer unit, for controlling direct memory access to the one or more computer readable storage devices for writing at least one subscriber data stream copied from the original data stream, the at least one subscriber data stream associated with at least one subscriber and written to a storage device location in the one or more computer readable storage devices associated with the at least one subscriber.

13. The system of claim 1 wherein the input controller is adapted to receive the original data streams in a variable bit rate format and store at least one of the one or more subscriber data streams in the variable bit rate format.

14. The system of claim 1 wherein at least one of the one or more subscriber data streams includes an index file generated by the DVR server.

15. A computer-implemented method for remote recording of digital data, the computer-implemented method comprising:
receiving, by an input controller device of a digital video recorder (DVR) server, an original data stream;
receiving and storing, by a buffer unit, at least a portion of the original data stream from the input controller; and
recording, using direct memory access, one or more subscriber data streams copied from the original data stream to one or more computer readable storage devices, each subscriber data stream associated with a subscriber and written to a storage device location in the one or more computer readable storage devices associated with the subscriber.

16. A computer program product, tangibly embodied in a machine-readable storage device, the computer program product including instructions being operable to cause a data processing apparatus to:
receive, by an input controller device of a digital video recorder (DVR) server, an original data stream;
receive and store, by a buffer unit, at least a portion of the original data stream from the input controller; and
record, using direct memory access, one or more subscriber data streams copied from the original data stream to one or more computer readable storage devices, each subscriber data stream associated with a subscriber and written to a storage device location in the one or more computer readable storage devices associated with the subscriber.
